(19) United States
(12) Patent Application Publication
(10) Pub. No.: US 2008/0149353 A1
(43) Pub. Date: Jun. 26, 2008

(54) Method of and apparatus for extinguishing the flame of a candle

(76) Inventor: David Valentine, New Fairfield, CT (US)

Correspondence Address: Albert W. Davis Jr., 6037 W. Robin Lane, Glendale, AZ, 85310, US

(21) Appl. No.: 12/072,795

(22) Filed: Feb. 27, 2008

Related U.S. Application Data
(63) Continuation of application No. 11/390,824, filed on Mar. 28, 2006.

(51) Int. Cl. A62C 3/00; F23D 3/16

(52) U.S. Cl. 169/46; 431/288

(57) ABSTRACT

The invention provides a method of and apparatus for extinguishing the flame of a candle that reduces the smell, smoke and soot which follow the extinguishing of the flame. The device draws gases proximate to the flame into apparatus thereby extinguishing the flame and passes the gases through a filter to clean the gas stream.

### TECHNICAL FIELD

The field of invention relates to candle extinguishing devices, and more particularly to candle extinguishing devices that reduce or eliminate the smell, smoke, and soot that emanate from an extinguished candle.

### BACKGROUND

Many homes and businesses use candles in order to provide a pleasant atmosphere, fragrance, and/or lighting. Unfortunately, when one extinguishes a candle flame, there is often smoke, and soot that emanates from the extinguished flame. Additionally, there is often an unpleasant odor from the extinguished flame. When more than one candle is extinguished, these unpleasant effects can by multiplied. Thus, there is a need for a device that can extinguish a candle flame that minimizes or eliminates the discharge of smoke, soot and odor into a room.

### SUMMARY

The invention provides a method of and apparatus for extinguishing the flame of a candle that reduces the smell, smoke and soot which follow the extinguishing of the flame. The device draws the flame and associated gases from the candle and passes the gases through a filter to clean the gas stream.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a cross-sectional schematic of one embodiment of the disclosed candle extinguishing device;

FIG. 2 is a cross-sectional schematic of another embodiment of the disclosed candle extinguishing device;

FIG. 3 is a cross-sectional schematic of still another embodiment of the disclosed candle extinguishing device;

FIG. 4 is a cross-sectional schematic of venturi embodiment of the disclosed candle extinguishing device;

FIG. 5 is a cross-sectional schematic of another venturi embodiment of the disclosed candle extinguishing device; and

FIG. 6 is a cross-sectional schematic of a compound fan embodiment of the disclosed candle extinguishing device.

### DETAILED DESCRIPTION

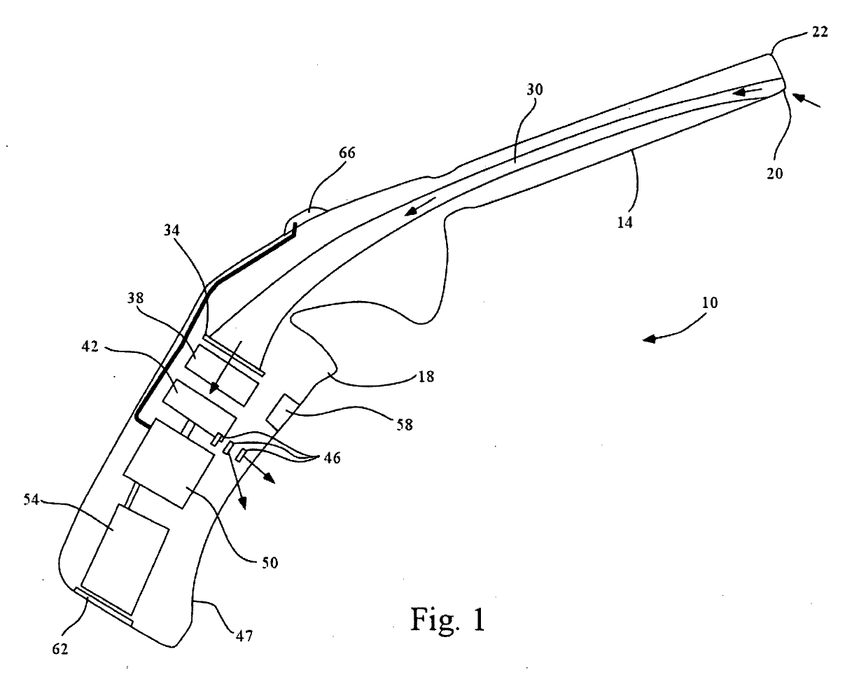

FIG. 1 is a cross-sectional schematic view of one embodiment of the disclosed candle extinguishing device 10. The candle extinguishing device 10 comprises a barrel 14 in communication with a handle 18. The barrel 14 has an extinguishing end 22, near to which there is an opening 26. The opening is in fluid communication with a passage 30 that travels from the barrel 14 into the handle until it reaches a partition 34, located in the handle 18. The partition may be a screen mesh configured to keep solid material from passing through. In fluid communication with the partition 34 is a filter 38. The filter 38 may be any suitable filtering material such as, but not limited to charcoal microcarbon filters, HEPA filters, electrostatically charged filters, activated carbon/charcoal filters, and zeolite filters. In fluid communication with the filter 38 is a fan 42. The fan 42 is in fluid communication with vents 46 located in the handle 18. The fan 42 is configured to draw air and other matter through the opening 26, through the passage 30, and into the filter 38, whereupon the air and matter is filtered, and the filtered air is discharged out vents 46. The vents 46 are shown located on an underside 47 of the handle, however one of ordinary skill in the art will recognize that the vents 46 may be located else where on the handle, and such alternatives are within the scope of this patent application. The fan is in operable communication with a motor 50, which is in electrical communication with a power supply 54. There may also be located on the handle 18 an entranceway with a filter door or panel 58 to allow a user to change and/or replace the filter 38. There may also be located on the handle 18 an entranceway with a power supply door or panel 62 to allow a user to change and/or replace the power supply 54. An activating means 66, such as a button, switch, or control knob, is located on the handle 18 and is in electrical communication with the motor 50 and is configured to turn on or off the fan, and may be further configured to adjust the fan speed. The candle extinguishing device 10 may be used as follows: the opening 26 is moved near a flame; the activating means 66 is activated thus turning on the fan and drawing air, soot, smoke, and odor from the flame into the passage 30 and into the partition 34 where any solid material is stopped from going further. The drawing air, soot, smoke, and odor continues into the filter 38 where the particulates and odor are removed, and the now cleaned air travels through the fan 42 and out the vents 46. Once the flame is extinguished, the user may deactivate the activating means 66 whereby the fan is stopped. In another configuration, there may be a delay means associated with the activating means 66 and/or motor 50, which allows for the fan 42 to keep running for a set time period, allowing the air, soot, smoke, and odor that has been drawn into the passage 30 to be filtered by the filter 42. Such a time period may be about 2 second to about 10 seconds. The arrows show the travel of the air, soot, smoke, and odor into the candle extinguishing device 10 until it is cleaned in the filter, and then arrows show the path the cleaned air takes as it travels out the vents 46. The candle extinguishing device 10 may also be operated as follows: use the device 10 to extinguish the flame, then draws soot, smoke etc. from a smoldering wick into the barrel 14 to the filter 38, also cooling the wick. The device 10 can perform two functions (1) extinguishing the flame and (2) removing most of the soot and smoke. In another embodiment of the device 10, a scented pad may be added such that the scented pad is adjacent to the filter 38. Additionally, the filter 38 may be located before the fan 42 as shown in FIG. 1, or after the fan (i.e. between the fan 42 and the motor 50).

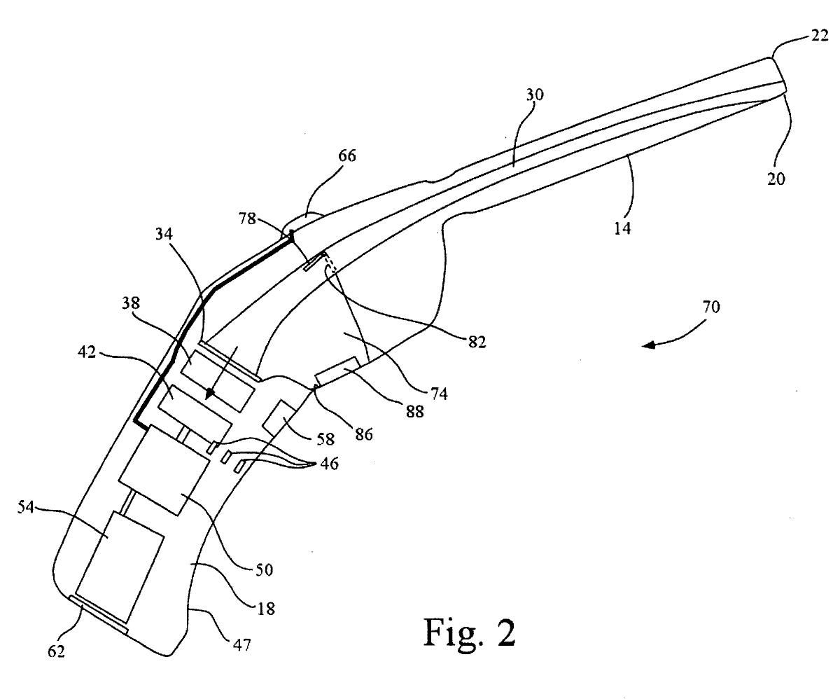

FIG. 2 shows another embodiment of the candle extinguishing device 70. In this embodiment, the passage 30 is in fluid communication with a chamber 74 located in the handle 18. A partition 78 is in rotatable communication with the passage 30 near the entrance 82 to the chamber 74. The partition is spring loaded to keep the partition shut until the fan 42 is turned on. Once the fan 42 is turned on, the partition opens (rotates to the left in the embodiment shown in FIG. 2). The chamber 74 is configured to hold and/or store any solid materials that may be drawn into the passage 30 when extinguishing a flame. The chamber is configured so that the solid materials may fall to the bottom 86 of the chamber 74 and not be drawn into the filter 38. However, if solid material does move toward the filter 38, it will be kept out of the filter 38 by the partition 34. In other embodiments the partition 78 may be located near the extinguishing end 22 of the passage. There may also be located on the handle 18 an entranceway with a chamber door or panel 88 to allow a user to remove any materials that may be located in the chamber 74.

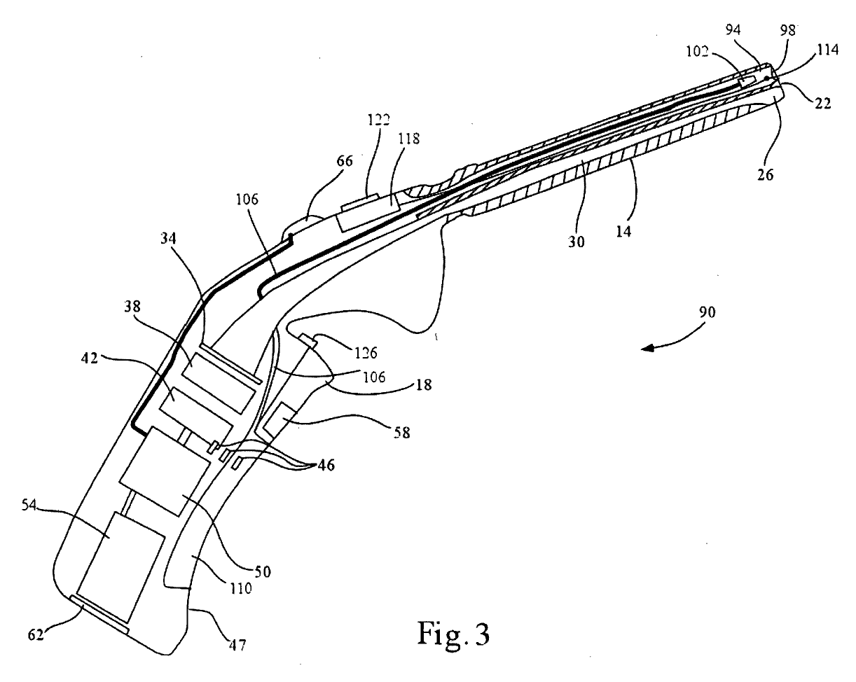

FIG. 3 shows another embodiment of the candle extinguishing device 90. In this embodiment, the candle extinguishing device 90 not only extinguishes flames, but is configured to also to light flames. The disclosed candle extinguishing device 90 has a second passage 94 located in the barrel 14. The second passage 94 is in fluid communication with a flame opening 98 located at or near the extinguishing end 22. An ignition tip 102 is located near the flame opening 98. The ignition tip 102 is in fluid communication with a fuel tube 106. The fuel tube 106 is in fluid communication with a fuel tank 110 which may be located in the handle 18. The fuel tank 110 is configured to hold an amount of lighter fluid such as a butane mixture. Located near the ignition tip 102 in the second passage 94 is a spark generating tip 114. The spark generating tip 114 is in electrical communication with a piezo electric unit 118 located in the handle 18. The piezo electric 118 unit is in communication with a lighter activating means 122, such as a button, knob or switch. Thus when the activating means 122 is activated by a user, the piezo electric unit creates a spark at the spark generating tip 114. Lighter fluid from the tank 110 is ignited at the ignition tip 102, thereby providing a flame to light candles and other items. There may be an activating means 126, such as a button, switch, or control knob, in communication with the fuel tank 110 that when activated allows lighter fluid to travel up the fuel tube 106 to the ignition tip 102. The activating means 126 may be a child proof device. The fuel tank may be refillable.

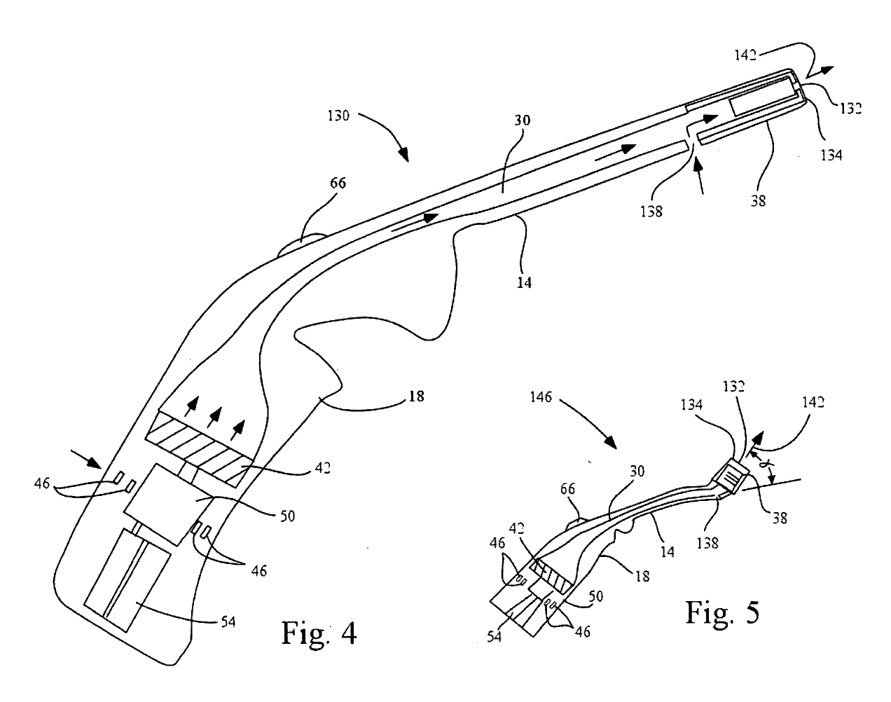

FIG. 4 shows another embodiment of the disclosed candle extinguishing device 130. In this embodiment, air enters the handle 18 through the vents 46 because the fan 42 is drawing air in. The air is blown up the passage 30 towards the filter 38, now located at a filter end 134 of the device 130. The barrel 14 and passage 30 has barrel opening 138. Flame, soot, odor and smoke are drawn into the barrel opening 138 via a venturi effect due to the air traveling in the passage 30 towards the filter 38. The air, soot, smoke and odor is pushed into the filter 38 via the air stream. Clean air exits the filter 38 and the device 130 at an exit opening 132. The arrow 142 shows generally the path the air takes as it leaves the filter 38.

FIG. 5 shows another embodiment of the disclosed candle extinguishing device 146. In this embodiment, the filter end 134 of the barrel 30 and filter 38 is generally positioned at an angle \acute{α} to the main portion of the barrel 30. This embodiment of the candle extinguishing device 146 works in generally the same way as the device 130.

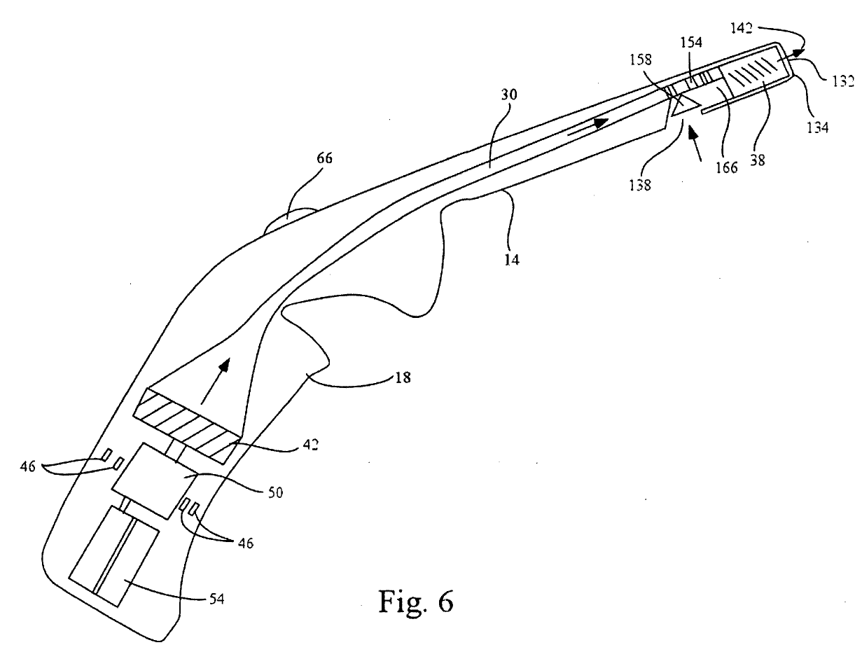

FIG. 6 shows another embodiment of the disclosed candle extinguishing device 150. In this embodiment, air enters the handle 18 through the vents 46 because, again, the fan 42 is drawing air in. The air is blown up the passage 30 towards an upper fan 154. The air flow drives the upper fan 154, which is in operable communication with a lower fan 158. The upper fan 154 drives the lower fan 158. The barrel 14 has an opening 162, which allows the flame, soot, odor and smoke air to be drawn in by the lower fan 158. The lower fan 158 is configured to direct air, soot, smoke and odor into the filter 38 via the second passage 166. Air exits the filter and the barrel 14 and travels generally in the direction of the arrow 142. The passage 30 and second passage 166 may or may not be in fluid communication with each other.

The disclosed candle extinguishing device has many advantages. Flames on candles, and other lit items such as, but not limited to: lamps, may be extinguished without the odor and smoke that accompanies flames that are be blown out or otherwise extinguished. In one embodiment, the candle extinguishing device may also include a lighter, all located in one unit. The candle extinguishing device provides for a compact unit that will extinguish flames and clean the air of the odors and smoke associated with the extinguished flame. The disclosed device is an indoor environment and air quality devise. It is recommended that candle flames not be blown out for safety reasons. Blowing out flames risks small pieces of hot wick or hot wax landing on flammable materials, causing a fire hazard, and allowing acrid smoke to fill room. The disclosed device eliminates these hazards.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A method of extinguishing the flame of a candle, comprising the steps of,
providing a candle having a flame,
providing a flame extinguishing device, the extinguishing device having a device for drawing a flow of gas with a power source and an on-off switch, the extinguishing device having a filter for filtering gases drawn from the flame,
switching the gas drawing device on,
positioning the extinguishing device proximate to the flame,
drawing gases from proximate to the flame into the extinguishing device to extinguish the flame and
passing the gases through the filter.

2. The method of claim 1 including the step of,
providing a scented device in the flow of gases to provide a scent to the gases.

3. The method of claim 1 including the step of,
incorporating a candle lighting device in the extinguishing device.
